(19) United States
(12) Patent Application Publication
(10) Pub. No.: US 2021/0241568 A1
(43) Pub. Date: Aug. 5, 2021

(54) ELECTRONIC CASINO GAME AND METHOD

(71) Applicant: Bernard J. Pavone, Harrison Township, MI (US)

(72) Inventor: Bernard J. Pavone, Harrison Township, MI (US)

(21) Appl. No.: 16/779,623

(22) Filed: Feb. 2, 2020

(51) Int. Cl. G07F 17/32

(52) U.S. Cl. CPC G07F 17/3209; G07F 17/3258; G07F 17/3288; G07F 17/3262; G07F 17/3293; G07F 17/3213

(57) ABSTRACT

A system and method of the inventive concept presents an electronic casino game and a mobile application. The present invention is directed to a method of playing a game using 54 cards. Unlike traditional wheel roulette game, the present invention includes more potential selected values (54 versus only 38), more ways to win (through both roulette-type bets, poker-type bets and progressive jackpot bets).

### FIELD OF INVENTION

This invention pertains generally to the field of card and table based casino electronic game, web based application and mobile device applications, and more particularly to a method, apparatus, and modern computer programming languages, internet networks, databases and application of cloud computing directed to a card and table game.

### BACKGROUND OF THE INVENTION

Casinos become more popular as years go by. Casinos try to compete with one another to attract attention of patrons. The casinos who have most exciting games will prevail because these games of chance will keep the patrons entertained and increase the choices and diversity of the games of chance located on the casino floors. There are several casino style games of chance that have been played for many years, such as Roulette, Black Jack, and Poker in limited forms. There have also been some recent inventive activities to find that one game which can find its place in the hearts of gamblers. The latter include game such as Black Jack, Roulette, Craps and Baccarat. Many of these games have evolved elaborate conventions, which are as well understood by experienced players, are intimidating to new table game players. Further, these games have rules, which may be simple once understood, but take some time to learn. For many players there is a fear that they will make a mistake and either appear foolish to the other players and staff or lose their money unnecessarily. As a result, many players only play electronic gaming machines, as they can make a mistake without embarrassment.

The art is widespread with various prior art references teaching different table games and methods. One of such prior art references discloses a specific game using a 121-card deck that seems to separate color and suit. However, nothing in the patent specifies that suit, color, and rank must be genuinely independent, and their exact relationship remains obscure. The deck is much too large for general use, and most standard games have no need of the patented game's implied restrictions on suit symbols.

Another prior art reference teaches a game that includes a deck of cards, tiles, or similar playing pieces, real or simulated on a computer or other device, chiefly characterized by a trilateral organization comprising three independent aspects: suit, value, and color or color group. The plurality of cards representing each element of each aspect comprise approximately equal pluralities of each element of each of the other aspects. Except for auxiliary cards, each card in a single deck represents a unique combination of a single suit, a single color group, and a single value or rank. The preferred form of the invention is a series of related triadic decks of playing cards comprising three suits and three color groups, nonsexist or gender-neutral picture cards, an improved layout, and indicative card backs. The layout improvement typically involves additional set designation markers in the two commonly vacant corners of a card face. Backs are uniform for all cards in a deck but different from deck to deck; the use of the elements of the back is sufficient to remind a player of the general configuration of the deck being used.

Still another prior art reference teaches a method for playing the casino game utilizing playing cards. The player makes at least one of the following wagers, a card value and suit, excluding Kings a suit, a suit color, and/or groups of card values and suits. From a standard deck of playing cards or preferably a standard deck of fifty-two cards with an additional Joker, a non-King playing card is randomly selected as the table card. If the table card does not correspond to any card value and/or suit or suit color wagered upon by the player, the players wager is lost and if the table card corresponds to a card value and/or suit or suit color wagered upon by the player, the player is paid an amount based upon his wager.

Still another prior art reference teaches a method of operating a casino card game. The game is played with one or more decks of cards. The game includes a playing surface includes first marked areas for placing wagers on one or more aspects of the face value of a single card. A second marked area for placing wagers on one or more aspects of the face values of a plurality of successively dealt single cards. The method permits the players to place wagers in the first and second marked areas. Then the dealer deals a single card. The dealer collects and pays the wagers placed in the first marked area according to the face value of the single card. The game permits the players to place new wagers in the first marked areas.

Still another prior art reference teaches a method to implement a roulette game that uses five (or any other number) wheels. A player can make individual bets on each of the individual wheels at the player's discretion, and when the player is done allocating his or her individual bets then the player spins the five wheels. After the wheels stop spinning, all of the player's bets on the table are resolved based on whether the bet is a winner for that particular wheel. Chips and wheels can be color (or pattern) coded so that chips appear differently depending on which roulette wheel those chips are being bet on. Chips that match the color (or pattern) of one the roulette wheels are associated with that wheel, and thus only the results of that particular roulette wheel matter to the resolution of the bet for that chip

Alluding to the above, it is important to add that roulette is a popular gambling game offered in many casinos around the world. American Roulette is a table game played with a dealer, or croupier, and a wheel with 38 equal-sized slots. Each of the 38 slots has a number and a color associated with it and printed in the slot. Two slots are given the numbers “0” and “00” and are colored green; these slots are at opposite ends of the wheel. In between the green numbers are 36 other slots (numbered one through 36), which alternate between 18 red slots and 18 black slots.

In a common variation, the numbers 2, 4, 6, 8, 10, 11, 13, 15, 17, 20, 22, 24, 26, 28, 29, 31, 33, and 35 are colored black; the numbers 1, 3, 5, 7, 9, 12, 14, 16, 18, 19, 21, 23, 25, 27, 30, 32, 34, and 36 are colored red. Upon play, the dealer spins the wheel in one direction and rolls a small metal ball in the other direction. When the wheel slows down, the ball settles into one of the numbered and colored slots. This number/color combination is the winner.

There are a variety of bets that may be made in a traditional roulette game. There is a table that players may place wagering chips on, and the values on this table correspond with the values imprinted in the 38 slots of the roulette wheel. This table customarily contains three columns of 12 numbers each, numbered from one through 36. Thus, the numbers 1, 2, and 3 are in the first row, numbers 4, 5, and 6 are in the second row, and so on. Each number is colored the same color that it is on the roulette wheel.

Above these numbers are usually places for the “0” and “00” green numbers. There are a variety of “inside bets” that may be played on the number grid (which contains numbers “0,” “00,” and 1-36). A player may bet on any one individual number coming up on the spin of the wheel by placing a wagering chip on that particular number on the gaming table; this often pays 35:1. By placing the chips in between two numbers, on a row of three numbers, on a diagonal corner in between four numbers, or between two rows, players can also bet on two, three, four, or six adjacent numbers at once.

A bet on two numbers (known as a “split bet”) usually pays 17:1. A bet on one row of three numbers (known as a “street bet” or “three number bet”) usually pays 11:1. A bet on a cluster of four numbers (known as a “corner bet” or “square bet”) usually pays 8:1. A bet on two rows of six numbers total (known as a “six-line bet”) customarily pays 6:1. To the side and bottom of the grid of numbers are usually other “outside bets” (bets on the grid of numbers itself are known as “inside bets”). These outside bets often include spaces where players may place chips in order to bet on red or black numbers, even or odd numbers, one column of numbers (e.g., 1, 4, 7, 10, 13, 16, 19, 22, 25, 28, 31, and 34), a group of numbers (1-12, 13-24, 25-36, 1-18, or 19-36), and possibly other variations.

Each of these outside bets offers a payout related to the odds against it hitting (for example, the red or black bets usually pay 1:1, as do the even or odd bets; the column bets pay 2:1, and the groups of numbers pay either 2:1 on groups of 12 numbers or 1:1 on groups of 18 numbers). The standard game of roulette, while popular, could be improved in a number of ways. First of all, the arrangement and colors of the numbers is simple and uninteresting. Judging by the immense popularity of card games (those using a standard 54-card deck of four different suits plus two jokers), players like the additional variation of thirteen different values of cards in four different suits (plus two “jokers”).

Roulette could be improved, made more interesting, and given additional and varied types of new bets by increasing the number of slots on the roulette wheel (and hence, on the matching betting table), by increasing the amount of numbers, colors/suits, or both. As conceived by the inventors of the present invention, roulette may also be played without a roulette wheel at all; instead, cards could be manually dealt or turned over, or selected by automated means on a computer screen. As discovered by the inventors, a roulette game using 54 values (52 cards plus two “joker” values) of five different suits (including jokers) can lead to many more and more interesting bets than can a conventional roulette game using only 38 values (36 plus the “0” and “00” values) of three different colors.

For example, as the inventors will show in the ensuing description, while traditional roulette allows players to bet on “red” or “black,” their advanced variation of roulette utilizing 52 card-based values would allow the player to bet on “spades,” “diamonds,” “clubs,” or “hearts;” and the player would still be able to bet on “red” or “black” cards, if he so desired. Additionally, standard roulette games use a single spin of the wheel and therefore a single selected value to determine the outcome of all bets made in a given betting round. Roulette could be made far more interesting and build more suspense for players with the addition of multiple selected values per betting round instead of a single one.

The combinations of spins that could produce a winning hand would be vastly increased, and the game would be made more interesting to players. Another flaw of roulette is that it does not offer the possibility of “side bets,” and the commensurately high pots that may be won in a high-odds, high-payout side bet. The addition of a “side bet” and additional ways to win (regardless of the number that is selected by the spinning of the roulette wheel) offers the possibility and excitement of two games in one—even if a player loses the main bet, he may still be able to win the side bet (or bets).

Additionally, the most that a player can win by picking an individual number in conventional roulette is 35:1. However, as conceived by the inventors of the present invention, the game could be improved and made more exciting to players and more profitable to casinos by introducing side bets that may pay 50:1, 1,000:1, 10,000:1, or even a progressive jackpot. The addition of such variations would likely make roulette more fun and exciting for players, as it increases the unpredictability of roulette, allows for the player to bet on two different types of games at once, and increases the payouts that a player may receive.

Further, as mentioned above, card games in general, and poker in particular, are very popular in America and around the world. Poker especially has benefited from a recent popularity explosion due to high-stakes tournaments being played that receive enormous national television coverage. There are many different poker tournaments, celebrity poker games, poker tutorials, and other poker-related shows on television; there are also countless poker-related sites on the Internet, where players may learn the rules of poker, be shown various strategies for playing poker, and even wager on poker games. Even laptop computers, personal digital assistants, and cell phones offer poker games for players on the go.

The game is so popular, several airlines now offer poker games on television screens embedded in each seat wherein players on a flight may compete against other players on that flight. If traditional roulette could tap into the popularity of poker, poker cards, and the rankings and odds of poker hands, it could be greatly improved. An improvement of roulette that offered the number-based betting of a roulette-like table layout and/or roulette-like wheel, concurrently with the use of playing cards and the five-card poker-hand-based betting of poker and poker games would be ideal.

Thus, there is a need in the art for a modified roulette game which addresses the drawbacks of traditional roulette described above. There is also a longstanding need and opportunity for new electronic games that will be easy to learn, fun to play, and more over will be exciting and attract attention of new patrons thereby generating revenue for the casinos. Moreover, there is another longstanding need and opportunity for applications for electronic games that can be used on mobile applications that will be easy to learn, fun to play, and more over will be exciting and attract attention of new users.

Variations such as those conceived by the inventors as introduced above and will be described in the following discussion are therefore likely to increase the popularity of roulette even further. Other advantages of the present invention will be apparent to one of ordinary skill in the art in light of the ensuing description of the present invention.

### SUMMARY OF THE INVENTION

An electronic gaming apparatus of the present invention includes a machine-readable medium having computer program code stored thereon which when executed by a machine causes the machine to perform a method of conducting an electronic game variation between users. The electronic gaming apparatus includes a user interface component, a controller of the electronic gaming apparatus performing dealer functions (a virtual dealer). For the web application the game is coded HTML5, java script, and Java where required. For the mobile apps a cross platform compiler that generates code for iOS and Android. This engine is multi-platform and supports a number of services simplified as Application Programming Interfaces (APIs). This includes what is called in the industry, In-App Purchase (IAP). The electronic version of the game can be a single user or a multi-user app that will allow users to compete against each other or the house. Players will be awarded a nominal amount of chips per login or may purchase virtual currency if they prefer.

The present invention uses object orient software such as JAVA, which is a high-level programming language and computing platform developed by Sun Microsystems in 1995. Java today is the foundation for most networked applications and is considered to be useful for scripting, web-based content, enterprise software, games and mobile applications. Java offers higher cross-functionality and portability as programs written in one platform can run across desktops, mobiles, embedded systems. Java is free, simple, object-oriented, distributed, supports multithreading and offers multimedia and network support. Java is a mature language, therefore more stable and predictable. The Java Class Library enables cross-platform development. Being highly popular at enterprise, embedded and network level, Java has a large active user community and support available. Java programs are compiled independent of platform in bytecode language which allows the same program to run on any machine that has a Java Virtual Machine (JVM) installed.

For the web application, HTML5 will be used as a programming platform. Most modern, popular browsers all support HTML5. HTML5 doctype was created in HTML5 to provide backward capability so that old browsers can use it.

Additionally, the method is disclosed of enabling a player to use a web site, a home computer or mobile devices via the Internet to enroll in a casino tournament gaming system, in addition to winning prizes offered as an outcome of a primary game on underlying gaming machines located in a casino. The method includes enabling enrollment in the casino tournaments of virtual rooms to form tournament teams using home computers, internet, web or mobile devices. The players may invite friends from their existing social networks. Prize winners are determined by number of entries. Winners are awarded game credits, comps in the form of virtual chips that are redeemable or playable in the future. In the physical casino's players can cash out from the electronic game consoles.

A first device connected to the controller to generate a first image element representing a table surface of a first color presenting a dealer section and players section.

The apparatus further includes a second device connected to the controller to generate a second image element representing a playfield including a plurality of sections with a first of the sections presenting several rows with each of the rows divided by cells wherein each cell present different kind of cards ranging from the card having the highest kind to the card having a lowest kind with all of the card being of a single suit allowing the players to place the bets anywhere in the sections.

The apparatus further includes a third device connected to the controller to generate a third image element representing a second of the sections extending from the first section presenting color identifiers allowing the players to place the bets on any of the color identifiers. Alluding to the above, the apparatus includes a fourth device connected to the controller to generate a forth image element representing a third of the sections extending from the first section presenting kind identifiers of various colors allowing the players to place the bets on any of the kind identifiers.

The apparatus includes a fifth device connected to the controller to generate a fifth image element representing a fourth of the sections extending from the first section presenting a row extending in parallel relationship with the several rows of the first sections and divided into cells of the fourth section and aligned with the cells of the rows of the first sections allowing the players to place the bets on any of the cells of the fourth section.

A sixth device is connected to the controller is used to generate a sixth image element representing a card section having a plurality of segment wherein the number of the segment equals to the number of gaming rounds played by the players to allow a dealer to place the cards on each of the segments. A central processing (CPU) unit is operably communicated with the controller for receiving information from the first device, the second device, the third device, the fourth device, the fifth device, and the sixth device to determine correlation between the first image elements through the fifth image elements presented to the users through the user interface component.

In alternative embodiment of the present invention, in invention, a computer program product for a mobile application for a mobile device is presented. The computer program product includes computer-readable program code. The computer-readable program code is executed in a tangible memory medium and is configured to perform an electronic game of the present invention. The computer program product comprising a user interface component, a controller performing dealer functions, and a first device connected to the controller to generate a first image element representing a table surface of a first color presenting a dealer section and players section.

The computer program product further includes a second device connected to the controller to generate a second image element representing a playfield including a plurality of sections with a first of the sections presenting several rows with each of the rows divided by cells wherein each cell present different kind of cards ranging from the card having the highest kind to the card having a lowest kind with all of the card being of a single suit allowing the players to place the bets anywhere in the sections.

The computer program product further includes a third device connected to the controller to generate a third image element representing a second of the sections extending from the first section presenting color identifiers allowing the players to place the bets on any of the color identifiers. Alluding to the above, the computer program product includes a fourth device connected to the controller to generate a forth image element representing a third of the sections extending from the first section presenting kind identifiers of various colors allowing the players to place the bets on any of the kind identifiers.

The computer program product includes a fifth device connected to the controller to generate a fifth image element representing a fourth of the sections extending from the first section presenting a row extending in parallel relationship with the several rows of the first sections and divided into cells of the fourth section and aligned with the cells of the rows of the first sections allowing the players to place the bets on any of the cells of the fourth section.

A sixth device connected to the controller is used to generate a sixth image element representing a card section having a plurality of segment wherein the number of the segment equals to the number of gaming rounds played by the players to allow a dealer to place the cards on each of the segments. A central processing unit is operably communicated with the controller for receiving information from the first device, the second device, the third device, the fourth device, the fifth device, and the sixth device to determine correlation between the first image elements through the fifth image elements presented to the users through the user interface component.

A software of the central processing unit is configured to calculate a plurality of winning options with each of the winning options presenting different winning combination values with the wagering section allowing the controller performing dealer functions to determine the winning outcome as the controller performing dealer functions opens a card placed in order to each of the segments of the card section and determining a winner of a jackpot after all cards placed on each of the segments define one of the winning options presenting different of winning combination values and the other of the side presenting the first color to match with the surface.

The present invention is directed to a method of playing a modified roulette game that generates additional excitement, player control, and more revenue for both players and casinos than conventional roulette. The present invention includes more potential selected values (54 versus only 38), more colors or “suits” (five versus three), more ways to win (through both roulette-type and poker-type bets), and more varied types of bets and side bets that may be made. The present invention also provides additional betting opportunities and an opportunity for larger payouts than conventional roulette games. Providing players with more opportunities to win and the opportunity for bigger payouts would certainly bring excitement and interest to players and will likely attract new players to the game. To achieve the foregoing and in accordance with the purposes of the present invention, the present invention is directed to a gaming method that comprises: a dealer shuffling a predetermined set of cards; each player placing one or more bets by placing wagers on designated betting areas of a gaming layout; dealing a plurality of community cards onto the playing table to be used communally by all players; the dealer revealing the values of the community cards; the dealer using a predetermined card to determine the result of all “roulette-type” bets; and the dealer resolving all bets according to payout schedules roughly corresponding to the odds of each event happening.

The gaming method may further comprise allowing each player to make one or more optional side bets based on the outcome of two or more of the community cards. One embodiment of the present invention is directed to a method of playing a modified roulette game comprising: (a) requiring each player to make at least one bet to participate in the game; (b) dealing five community cards face down from a standard 54-card deck (including two jokers); (c) revealing the five community cards dealt; (d) using the fifth community card dealt to determine the outcome of roulette-type bets by comparing the fifth community card value with the roulette-type bets placed by the players; and (e) resolving all bets. In step (a) the player may make one or more roulette-type bets (based on the outcome of the fifth community card dealt) and one or more optional side bets based on the outcome of two or more of the community cards. For example, a player may make a side bet that the five community cards dealt will form a winning five-card poker hand (poker-type bet) or that both the first and fifth community cards dealt will be jokers (Wild Viking bet).

Another aspect of the present invention is directed to a gaming layout which includes a plurality of community card positions and a wagering area comprised of multiple betting positions that represent the various types of bets that the player can make. For example, a gaming layout of one embodiment would comprise of betting positions that correspond to the following types of bets: any single card, any two adjoining specific cards, any four specific adjoining cards, any number, any adjoining pair of numbers, any particular suit, any particular block of four numbers, any particular block of six numbers, red/black, even/odd, Wild Viking bet, poker bet, and progressive jackpot bet.

The markings on the gaming layout would correspond to those available in a standard 54-card deck of playing cards (including two jokers). These markings would be arranged in rows and columns to easily facilitate betting on groups; for example, bets on any value (such as “any King”), or any suit (such as “spades”) could be made by placing a bet on an entire column or row of similar values. Players could also bet on several numbers at once through the use of various traditional roulette-type wagers, such as split bets, two-number-bets, four-number bets, or eight-number bets (as described above).

Additionally, there could be places on the gaming table to allow for bets on either or both joker values, on even or odd numbers, on different colored numbers (for example, red or black), on a range of values (for example, between ten and King, inclusive), or on a subset of the entire range of values available (for example, greater than seven). Further, there could be places on the gaming layout to allow for side bets on the result of a five-card poker hand that is selected through some combination of playing cards (manual or electronic) and possibly a spin of a modified roulette wheel. Such wagers would bet on the composition and ranking of the five-card poker hand produced. These bets would pay varying amounts based on the rarity of each poker hand appearing, and would wager for the occurrence of poker hands such as one pair, Jacks or better, two pairs, three of a kind, straight, flush, full house, four of a kind, straight flush, Royal Flush, or five of a kind.

Additional wagers and payouts could be based on special occurrences, such as the presence of a joker in a certain position (for example, a joker appearing as the first and/or last of the five card values selected). The above description sets forth a summary of embodiments of the present invention so that the detailed description that follows may be better understood and contributions of the present invention to the art may be better appreciated. Some of the embodiments of the present invention may not include all of the features or characteristics listed in the above summary.

There may be, of course, other features of the invention that will be described below and may form the subject matter of claims. In this respect, before explaining at least one embodiment of the invention in further detail, it is to be understood that the invention is not limited in its application to the details of the construction and to the arrangement of the components set forth in the following description or as illustrated in the drawings. The invention is capable of other embodiments and of being practiced and carried out in various ways. Furthermore, it is to be understood that the phraseology and terminology employed herein are for the purpose of description and should not be regarded as limiting.

Other features, aspects and advantages of the present invention will become apparent from the following description of the invention, taken in conjunction with the accompanying drawings, which illustrate, by way of example, various features of embodiments of the invention.

An advantage of the present invention is to provide a new game of chance that incorporates the excitement of a traditional roulette game, a poker game and a progressive jackpot. This invention gives the players a potential high payout from their wager and increasing their choices. Casinos have progressive jackpot to attract players to play by offering huge jackpots. This invention uses a progressive jackpot controller that could network a single or multiple sites across the country. This allows players to win and the opportunity for bigger payouts would certainly bring excitement and interest to players and will likely attract new players to the game.

Another advantage of the present invention is to provide this invention in other forms. This includes, mobile applications, web based applications that can be played on personal computer or tablet, slot machine type consoles and and electronic virtual dealer. These choices will allow and attract those who may be intimidated by existing table games and other players.

Still another advantage of the present invention is to provide a game that is easy to be explained to those who have never played the games before.

Still another advantage of the present invention is to provide a new game and a mobile application wherein no elaborate strategies or systems need to be learned by the players to play and enjoy the game.

Other advantages and meritorious features of this invention will be more fully understood from the following description of the preferred embodiment, the appended claims, and the drawings; a brief description of which follows.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates a perspective view of a gaming machine.

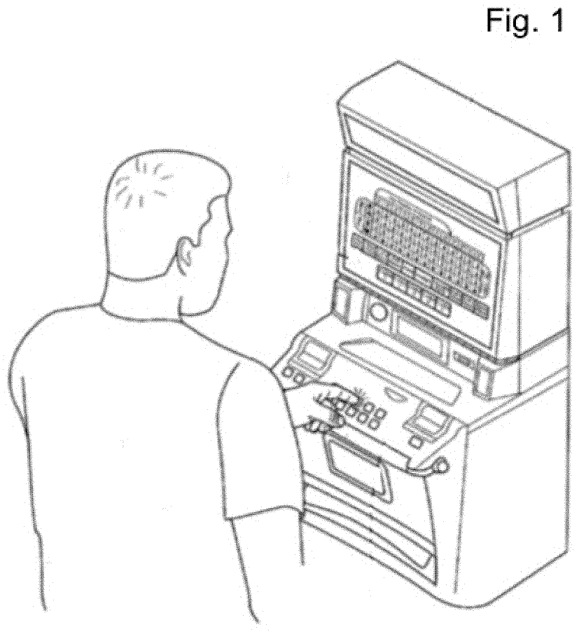

FIG. 2 illustrates an enlarged view of the game layout.

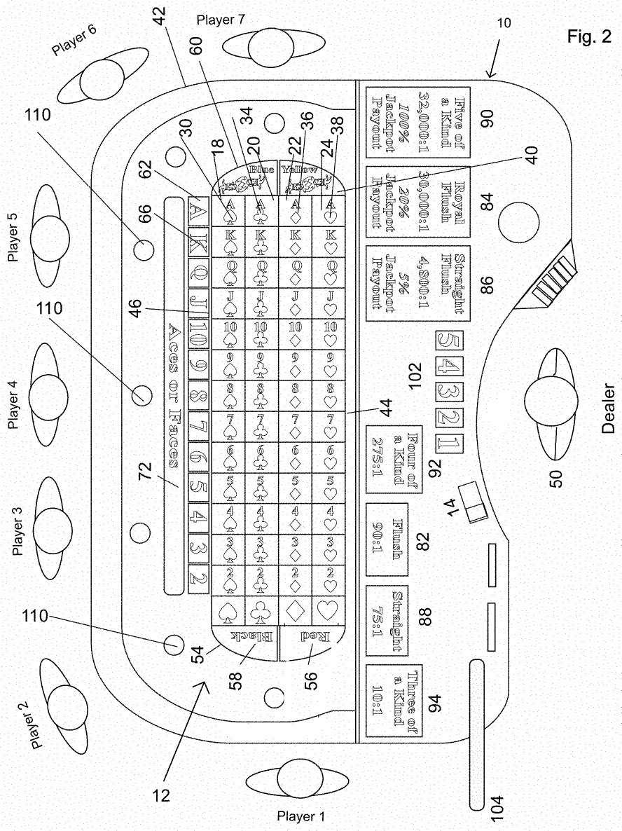

FIG. 3 illustrates a front view of the present invention as a mobile phone application.

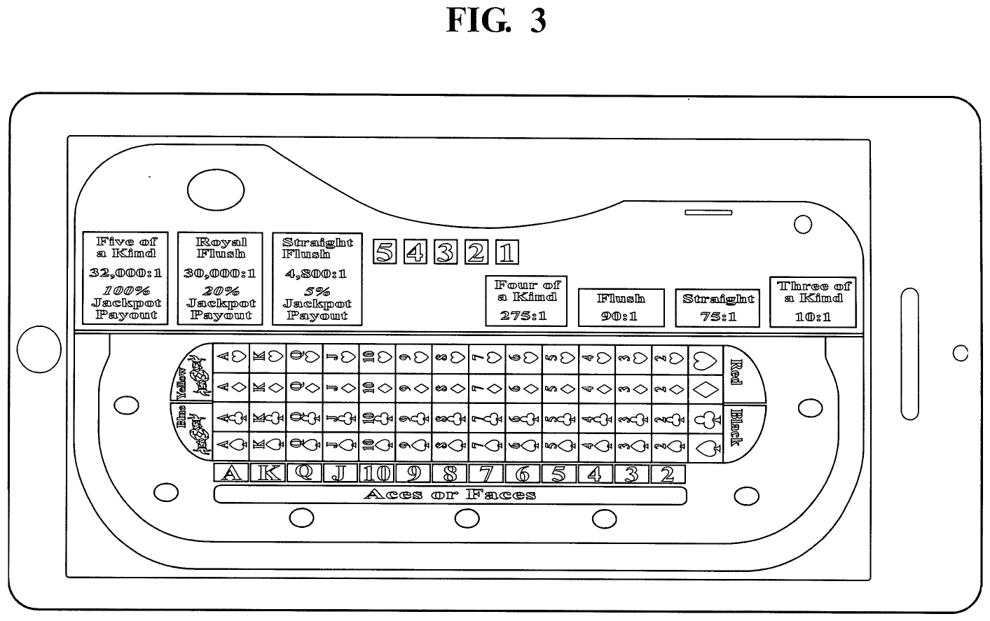

FIG. 4 illustrates the invention as an application on a tablet.

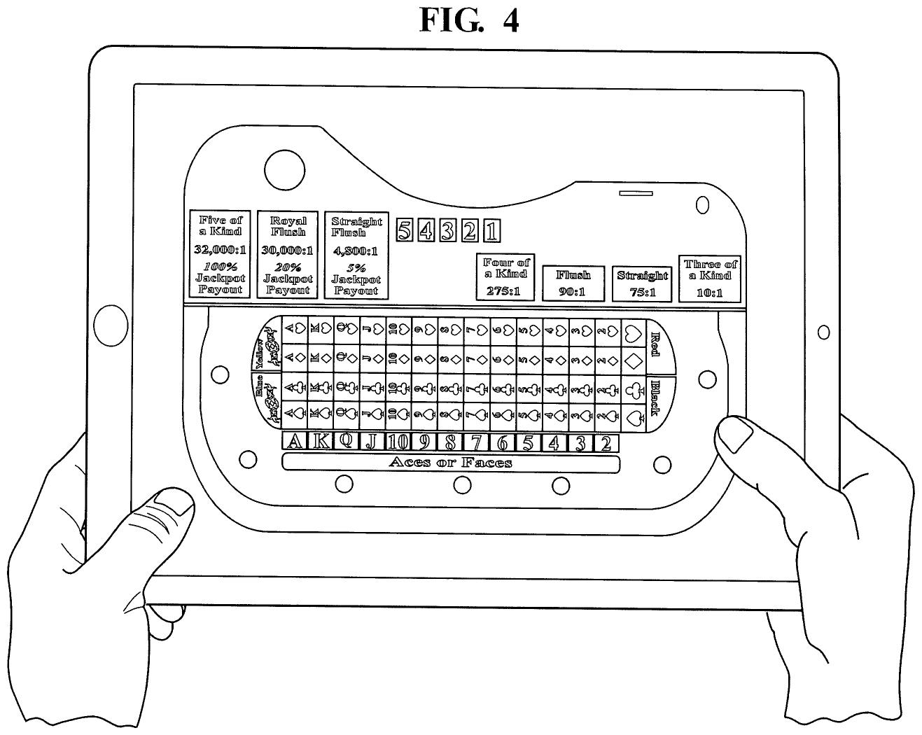

FIG. 5 illustrates a prospective view of the present invention.

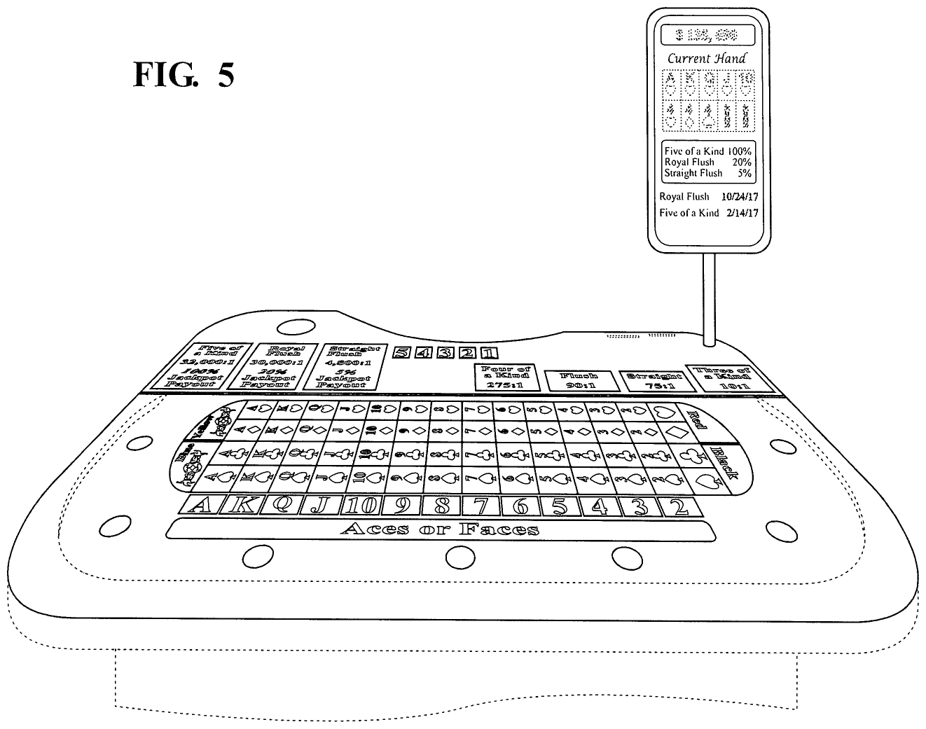

FIG. 6 illustrates a logical view of the cloud-based infrastructure using Platform-as-a Service for hosting and delivering the present invention.

FIG. 7 illustrates a flow chart of the rules of the game.

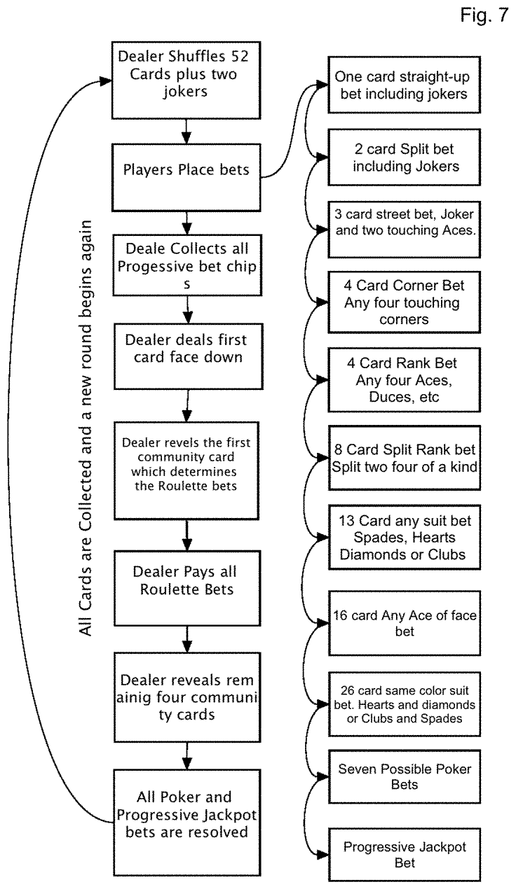

FIG. 8 illustrates a front view the invention as a web app or an app on a personal computer.

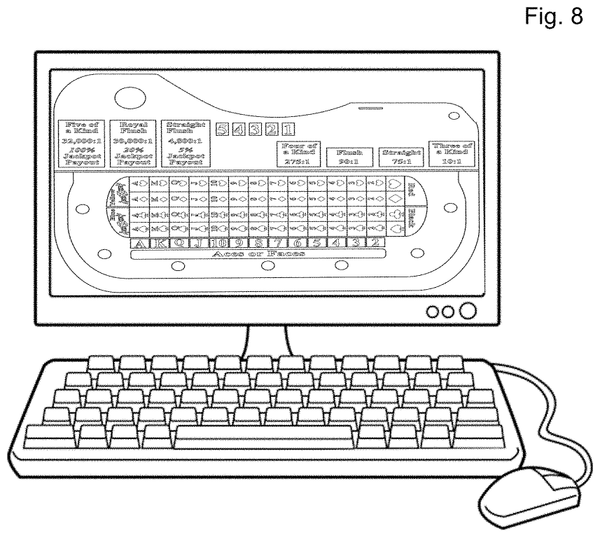

FIG. 9 illustrates House edge and RTP analysis tables. Mathematical analysis tables of the above-described embodiments was conducted by BMM Labs and Total Gaming Science A computer simulation was developed to compute the probability distribution and the house advantage.

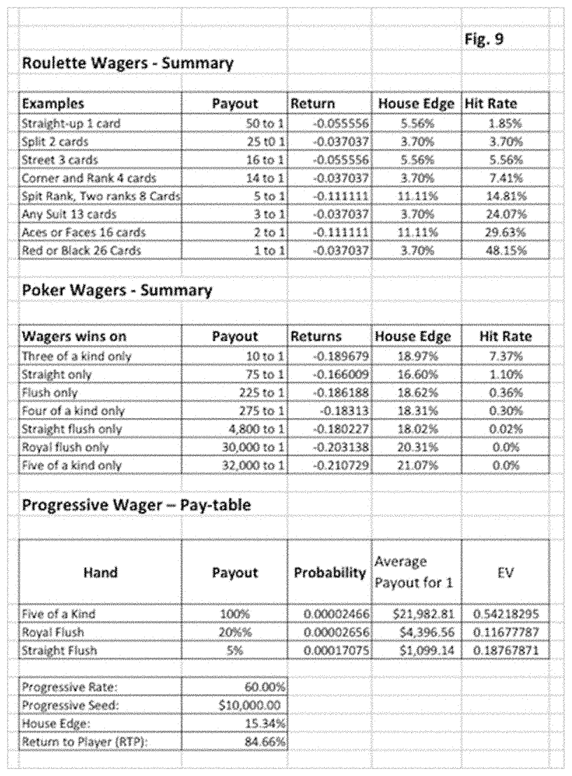

FIG. 10 illustrates LCD/LED Progressive Jackpot display tree.

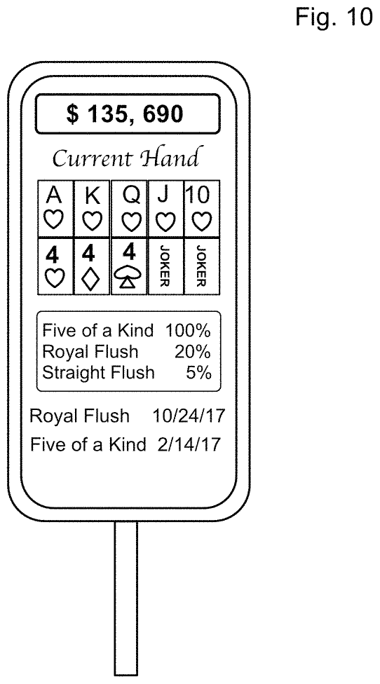

FIG. 11 illustrates the invention with a virtual electronic dealer.

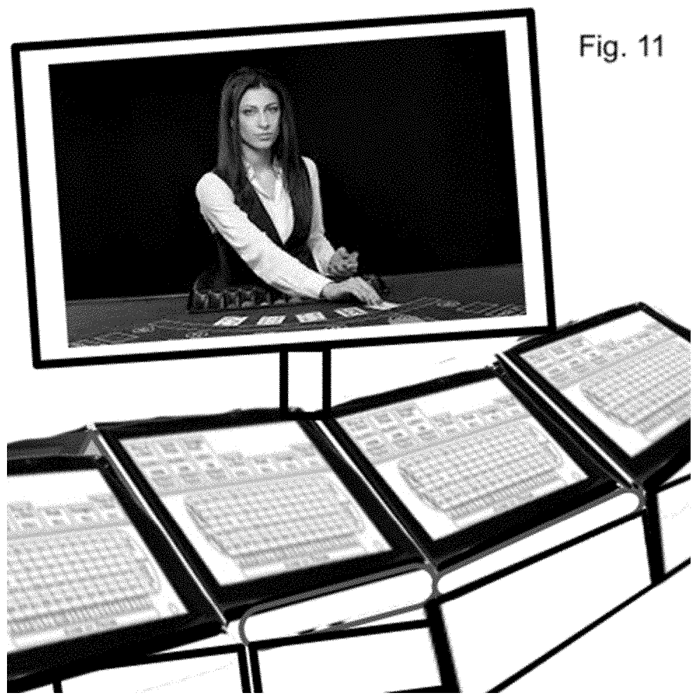

### DETAILED DESCRIPTION OF THE INVENTION

There are about fifty-four cards in the game 10. The representations of the playing card disposed on the tabletop 12 can be in script, graphical form, or any combination of both. The game is played with the dealer D, who deals the cards and represents the “house” and with players P1 through P6 (more players can be involved to play the game without limiting the scope of the present invention) whom make the wagers.

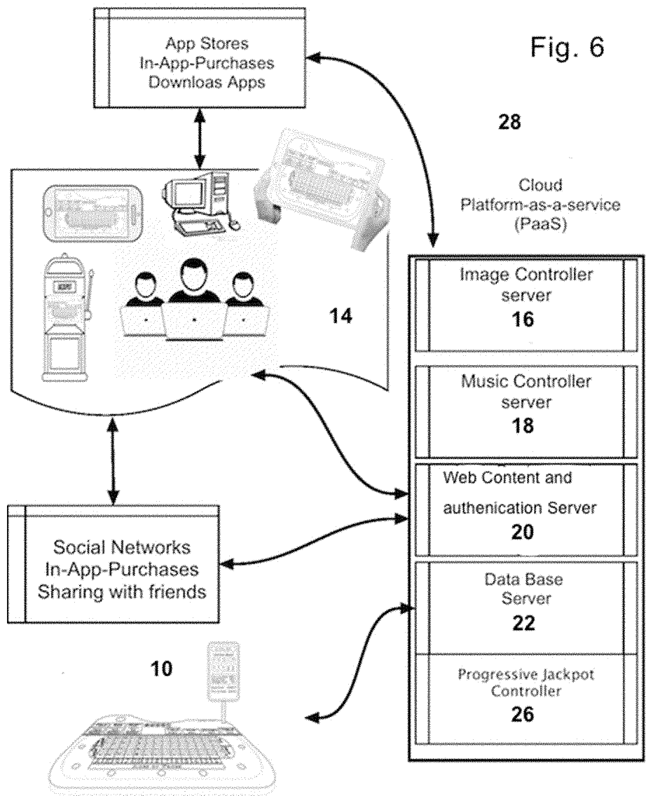

A system of the present invention is generally shown at 10 in FIG. 6. The system 10 present a web based application. The system 10 includes a website having at least an interface component 12 adaptable to receive information from users 14 through the user personal devices such as, a mobile phone, a personal computer, and the like. The number of the users 14 is unlimited and reference to a first user and a second user as will be mentioned below is not intended to limit the scope of the present invention and are presented for explanatory purposes. The interface component 12 is operably communicated with an image controller 16 for storing and circulating first test elements, such as images, video, and other type of information to be presented to the users 14 so the users can make a selection of the first test element based on the user's preference.

The system includes a music controller 18 for storing and circulating second test elements, such as music, songs, and any other types of audio recording to be listened by the users 14 so the users 14 can make a selection of the second test element based on the user's preference. Each user 14 will use a screen that will appear of the user's personal devices such as, the mobile phone, the personal computer, and the like.

The screen (not shown) will provide the user 14 with several options that will allow the user 14 to either indicate what option the user 14 likes or dislikes as the first and second test elements presented to be selected by the user or if the user prefers not to make a selection. Various screen designs may be used with the present invention without limiting the scope of the present invention. The servers for system 10 would be housed in the cloud using Platform-as-a Service (PaaS). This includes a web content and authentication server 20 with all of the aforementioned components being coordinated with one another and adaptable to receive and exchange information between each other.

A Progressive Jackpot Control 26 and Data Base server 22 is configured to receive information from the Web Content an authentication server 20. The Data Base Server houses all the players' account information, communicated with a content delivery network or Platform-as-a-Service (PaaS) 28. As appreciated by those skilled in the art a cloud computing environment is a system of computers servers containing copies of data placed at various nodes, such as the nodes of the present invention.

The PaaS 28 improves access to the data it caches by increasing access bandwidth and redundancy and reducing access latency. There numerous data types cached in the PaaS 28 of the present invention. These data include web objects, downloadable objects (media files, software, documents), applications, live streaming media, and database queries without limiting the scope of the present invention. PaaS (Platform as a Service) in cloud computing reduces costs, increases speed of development and deployment by providing need needed bandwidth and computing power as needed dynamically. PaaS can provide greater speed, flexibility, and agility to the rapidly providing a predictable, heterogeneous online application infrastructure.

To start a game, the players place the wagers (e.g. casino chips, cash, tangible property) anywhere on the entire playing field 16. The wagers can be placed on the aforementioned sections, the players may bet, or single round wager, the individual card to come out next. They may bet:

Roulette Wagers, which will cover one or more cards and will win if the Roulette Card is one of the cards covered by the player's wager; the available Roulette Wagers are as follows:

Roulette Wagers Payouts

| # of Cards | Example | |
|---|---|---|
| 1 | One card straight-up bet including jokers. | 50:1 |
| 2 | Two cards Split bet including Jokers | 25:1 |
| 3 | Three cards street bet, Joker and two touching Aces. | 16:1 |
| 4 | Four cards corner bet | 12:1 |
| 4 | Four cards rank bet (Any Jacks and Deuces, etc.). | 12:1 |
| 8 | Eight-cards split rank bet, split Two Four of a kinds | 6:1 |
| | rank | |
| 13 | Thirteen cards suit bet (Any suit bet [symbol] , ♥, [symbol] or ♦). | 3:1 |
| 16 | Sixteen cards bet (Any Ace or Face A, K, Q or J). | 2:1 |
| 26 | Twenty-six cards same color suits, Red or Black. | 1:1 |

Poker Wagers, in which the player will select a specific hand rank, and the player will win if the final five-card hand is that rank and that rank alone; the available Poker Wagers are as follows:

### Poker Wagers

| Wagers wins on | Payout |
|---|---|
| Five of a Kind only | 32,000:1 |
| Royal Flush only | 30,000:1 |
| Straight Flush only | 4,800:1 |
| Four of a kind only | 275 to 1 |
| Flush only | 225 to 1 |
| Straight only | 50 to 1 |
| Three of a Kind only | 10:1 |

c. The Progressive Wager, which is made by placing S1 on a marked progressive spot at the start of the hand. The S1 wager is collected at the start of play. The Progressive Wager pays out for a final five-card poker hands that is better than four of a kind. If there are multiple winners, Progressive jackpot payouts are split equally among all players that made the Progressive Wager.

### Progressives Jackpot Wagers

| Wager Wins on | Payout |
|---|---|
| Five of a kind | 100% |
| Royal Flush | 20% |
| Straight Flush | 5% |

Once all players have made their wagers, any Progressive Wagers are collected. Then, the first card will be dealt face-down (burn card) onto the area designated as spot one. Immediately, a second card is dealt face-up on top of the first card. This card that is dealt face-up determines the outcome of all Roulette bets. The house may choose to implement whatever policy of dealing, burning and card delivery it deems necessary for game protection; this will not impact the underlying mathematics.

As long as each of the five outcomes is equally likely, the house may choose to implement whatever method they choose of randomly selecting which of the five cards is the Roulette Card, such as: a. Always using the first card. b. Using a electronic random number generator or a wheel, where each number between 1 and 5 has an equal 20% probability of occurring.

First, all the Roulette Wagers are resolved and paid off.

Next, the remaining four poker cards are turned face up, and the five cards are read as a single five-card poker hand; based on the value of this hand, the Poker Wagers and the Progressive Wager are resolved according to the supplied pay-tables. The best poker hand is always the winner. All cards are collected, and a new round may begin.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An electronic gaming apparatus comprising a machine-readable medium having computer program code stored thereon which when executed by a machine causes said machine to perform a method of conducting an electronic game variation between users, said electronic gaming apparatus comprising:
at least an interface component adaptable to receive information from users through the user personal devices such as, a mobile phone, a personal computer; the interface component is operably communicated with an image controller for storing and circulating first test elements, such as images, video, and other type of information to be presented to the users so the users can make a selection of the first test element based on the user's preference;
a music controller for storing and circulating second test elements, such as music, songs, and any other types of audio recording to be listened by the users so the users can make a selection of the second test element based on the user's preference;
a Progressive Jackpot Control module and a Data Base server is configured to receive information from a Web Content an authentication server, wherein the Data Base Server houses all the players' account information, communicated with a content delivery network or Platform-as-a-Service (PaaS) module; and
the Platform-as-a-Service (PaaS) module adaptable to improve access to the data it caches by increasing access bandwidth and redundancy and reducing access latency, wherein the numerous data types cached in the Platform-as-a-Service (PaaS) module, wherein the Platform-as-a-Service (PaaS) module in cloud computing reduces costs, increases speed of development and deployment by providing need needed bandwidth and computing power as needed dynamically and to provide greater speed, flexibility, and agility to the rapidly providing a predictable, heterogeneous online application infrastructure.
